(19) United States
(12) Patent Application Publication
(10) Pub. No.: US 2008/0163629 A1
(43) Pub. Date: Jul. 10, 2008

(54) Refrigerant measuring device and sensor thereof

(76) Inventor: Chiang Kao Chen, Hsin Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/649,276

(22) Filed: Jan. 4, 2007

(51) Int. Cl. F25B 49/00; G01K 13/00; F25B 45/00

(52) U.S. Cl. 62/129; 62/149

(57) ABSTRACT

A refrigerant measuring device includes a casing, at least one sensor, and a detection circuit. The casing forms a plurality of coupling connector for selectively jointing sources of refrigerant to be detected to receive the refrigerant. The coupling connectors are connected to a channel to which the sensor is connected. The sensor includes an enclosure, a pressure detection circuit, and a thermocouple. The enclosure forms a connector to connect the channel and defines an interior chamber connected to the connector through a pressure-reducing neck that guides the refrigerant in a pressure-reduced condition into the chamber to contact the pressure detection chip and the thermocouple for detection of pressure and temperature of the refrigerant. The detection circuit receives the detected pressure and temperature from the sensor and also receives data of standardized reference pressure and temperature from a memory and display the detected pressure and the temperature and the reference data on a display.

### BACKGROUND OF THE INVENTION

1. Field of the Invention

The present invention generally relates to a refrigerant measuring device, and in particular to a refrigerant measuring device that displays detected pressure and temperature of the refrigerant and standardized reference data for comparison. The present invention also relates to a sensor for detecting pressure and temperature of refrigerant.

2. The Related Art

Air-conditioning devices and refrigerating facility employs heat absorption caused by isothermal expansion of compressed refrigerant is well known. Apparently, these devices must be filled with a proper amount of refrigerant for proper operation. Conventionally, a pressure gauge is used to monitor the amount of refrigerant that is being filled into a refrigerating device. The conventional pressure gauge is an analog device of which the reading often incorrectly obtained due to human eye error. In addition, the temperature of the refrigerant that is being filled into the refrigerating device cannot be monitored. Further, reference data of refrigerant filling are usually not available on site for comparison, which is often troublesome to the site operator in determining the proper amount of refrigerant filled into the refrigerating device.

Thus, the present invention is aimed to provide a refrigerant measuring device that overcomes the above troubles.

### SUMMARY OF THE INVENTION

An objective of the present invention is to provide a refrigerant measuring device, comprising: a casing having a plurality of coupling connectors for respectively selective connection with a source of refrigerant to be detected. The casing forms an internal channel connecting and in fluid communication with the coupling connectors to receive the refrigerant to be detected. At least one sensor is mounted to and in fluid communication with the channel to physically contact the refrigerant for detection of pressure and temperature of the refrigerant. A detection circuit comprises a signal conversion circuit that is coupled to the sensor to receive and convert the detected pressure and temperature into signals applied to and processed by a microprocessor. A memory storing sets of reference data of standardized pressure and temperature. A keyboard is coupled to the microprocessor to control the microprocessor for displaying the detected pressure and temperature of the refrigerant and selectively displaying the reference data of the standardized pressure and temperature on a display device. A power supply powers the refrigerant measuring device.

Another object of the present invention is to provide a sensor comprising an enclosure having an end forming a connector that connects with a source of a refrigerant to be detected to receive the refrigerant. The enclosure forms an interior chamber in fluid communication with the connector by means of a pressure-reducing neck that reduces pressure of the refrigerant and guides the pressure-reduced refrigerant into the chamber. A pressure detection chip extends into the chamber to detect the pressure of the refrigerant guided into the chamber. A thermocouple extends into the chamber to detect temperature of the refrigerant guided into the chamber.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view showing a refrigerant measuring device constructed in accordance with the present invention;

FIG. 2 is an end view, partly sectioned, of the refrigerant measuring device of the present invention;

FIG. 3 is an exploded perspective view, partly broken, of a sensor of the refrigerant measuring device of the present invention;

FIG. 4 is a cross-sectional view of the sensor of the present invention;

FIG. 5 is a block diagram of a control circuit of the refrigerant measuring device of the present invention; and

FIG. 6 is a schematic view illustrating an example layout of a display device and a keyboard of the refrigerant measuring device in accordance with the present invention.

### DETAILED DESCRIPTION OF THE PREFERRED EMBODIMENT

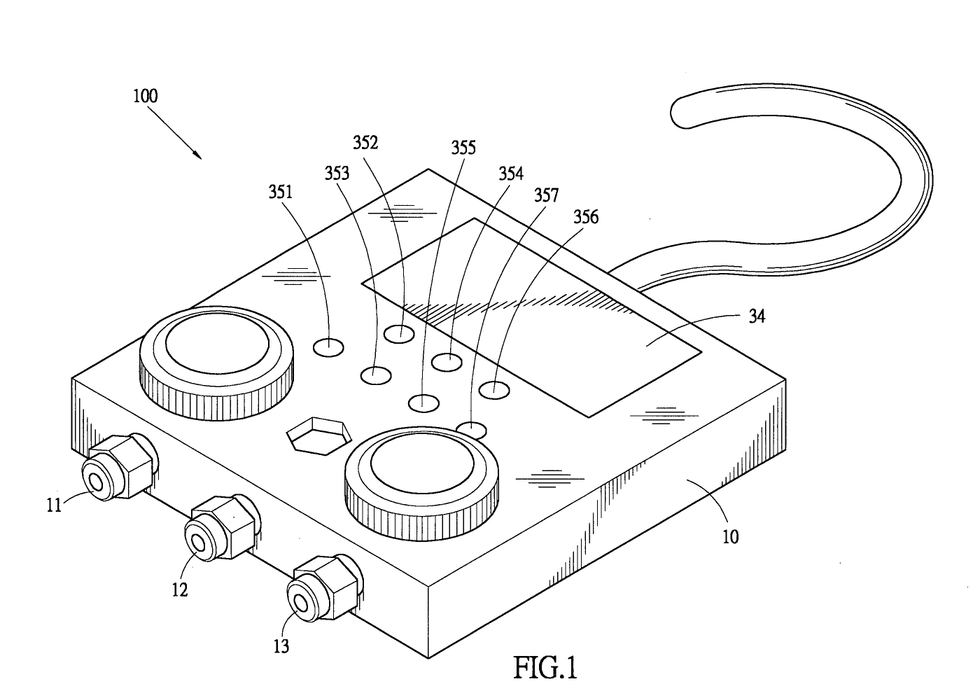

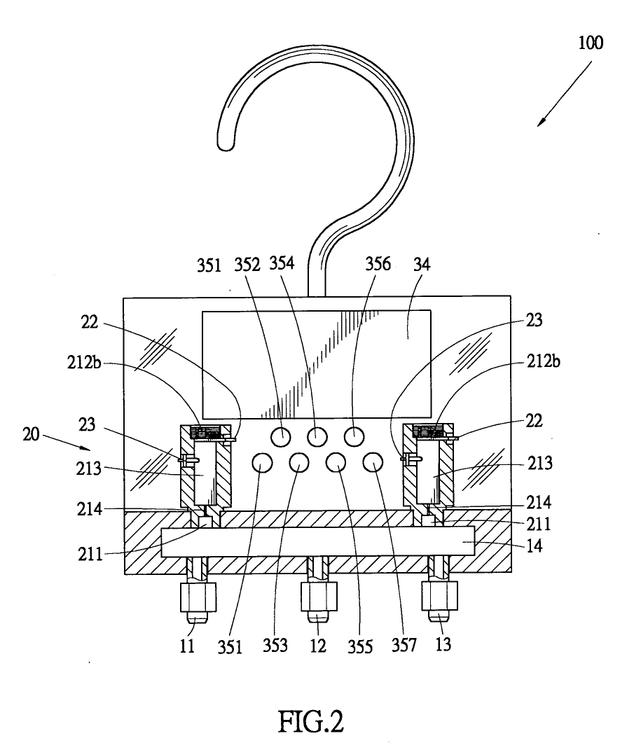

With reference to the drawings and in particular to FIGS. 1 and 2, a refrigerant measuring device constructed in accordance with the present invention, generally designated with reference numeral 100, comprises a casing 10, at least one sensor 20, and a detection circuit 30. The casing 10 forms a plurality of coupling connectors 11, 12, 13, for releasable connection with refrigerants to be detected. The casing 10 also forms an internal connection channel 14 that is in fluid communication with all the coupling connectors 11, 12, 13.

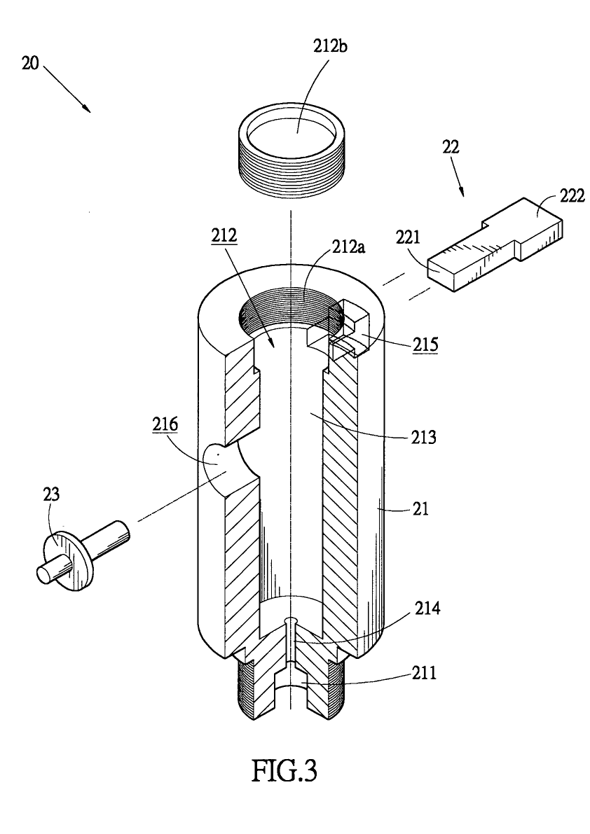

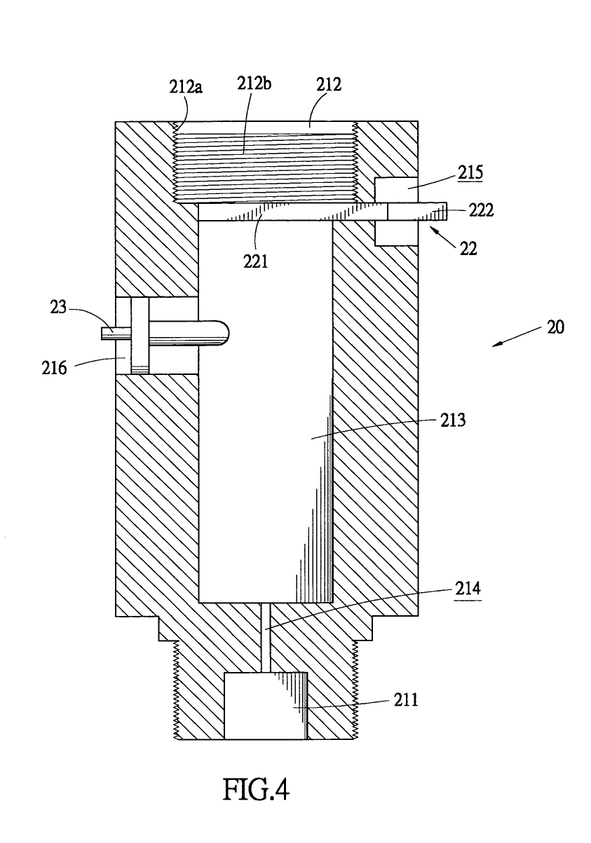

Also referring to FIGS. 3 and 4, the sensor 20 in accordance with the present invention comprising an enclosure 21, a pressure detection chip 22, and a thermocouple 23. The enclosure 21 has an end forming a connector 211 defining an inlet port (not labeled) and an opposite end forming an inner-threaded bore 212. The sensor 20 is arranged inside the casing 10 of the refrigerant measuring device and is connected to and in fluid communication with the connection channel 14 with the connector 211 thereof (see FIG. 2). In the embodiment illustrated in the drawings, two sensors 20 are illustrated and are shown at locations adjacent to opposite ends of the connection channel 14. However, the number of sensors 20 can be increased and decreased, if desired, and the sensors 20 can be connected to any desired locations along the channel 14.

The bore 212 has an internal thread 212a engageable with a lock plug 212b that is externally threaded. The lock plug 212b will be further described.

The casing 21 defines an interior chamber 213, which is connected to and in fluid communication with the inlet port of the connector 211 by a pressure-reducing neck 214. The neck 214 has an inner diameter that is much smaller than the diameters of the inlet port of the connector 211 and the chamber 213. Refrigerant to be detected is allowed to enter the sensor 20 through the inlet port of the connector 211 and flows through the neck 214, by which the pressure of the refrigerant is reduced, to enter the chamber 213.

The enclosure 21 also forms two openings 215 and 216, both in fluid communication with the interior chamber 213.

The pressure detection chip 22 has an inner, sensing end 221, which serves to detects the pressure of the refrigerant in contact with the sensing end 221, and an outer lead-connection end 222, which generates a detection signal corresponding to the pressure detected by the sensing end 221. The pressure detection chip 22 is received in the opening 215 with the inner end 221 projecting into the chamber 213 and located between the inner-threaded bore 212 and the chamber 213, as shown in FIG. 4. The lock plug 212b that is received in the bore 212 physically engages and thus applies a force on the sensing end 221 of the pressure detection chip 22 to secure fix the sensing end 221 at a position between the bore 212 and the chamber 213 for detection of the pressure of the refrigerant that has been reduced in value by the neck 214. The corresponding pressure detection signal is then generated at the outer end 222 of the chip 22.

The thermocouple 23 extends into the chamber 213 through the opening 216 to detect the temperature of the pressure-reduced refrigerant inside the chamber 213 and to provide a temperature detection signal corresponding to the temperature of refrigerant.

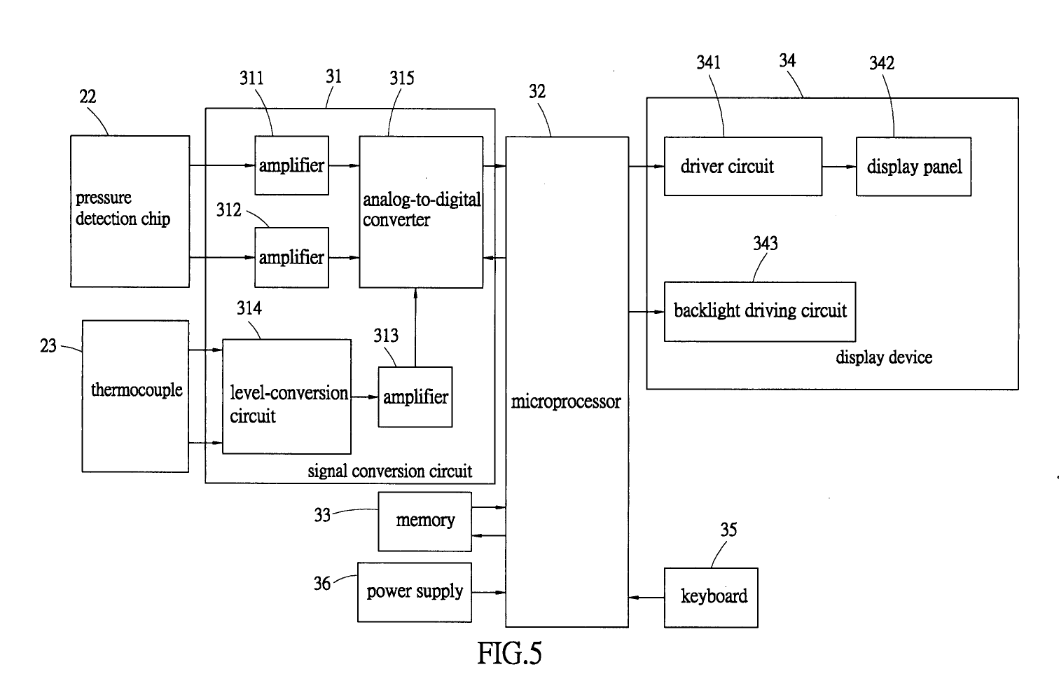

Also referring to FIG. 5, which shows a block diagram of a control circuit 30 of the refrigerant measuring device 100, the control circuit 30 is shown as an illustrative example, not to limit the scope of the present invention. The control circuit 30, which is arranged inside the casing 10, comprises a signal conversion circuit 31, a microprocessor 32, a memory 33, a display device 34, a keyboard 35, and a power supply 36. The signal conversion circuit 31 can be of any known circuit, provided it converts input signals into signals that can be processed by the microprocessor 32 or equivalent electronic devices thereof. An example of the signal conversion circuit 31 as shown in the drawings comprises amplifiers 311, 312 that are connected to output terminals of the lead-connection end 222 of the pressure detection chip 22 to receive and amplify the pressure detection signal. The amplified pressure detection signal is then converted by an analog-to-digital converter 315 into a digital signal that is then applied to the microprocessor 32.

The signal conversion circuit 31 also comprises a level-conversion circuit 314, preferably a transistor or thyristor based device, which receives the temperature detection signal from the thermocouple 23 and converts a level of the temperature detection signal into a desired range. For example, the level-conversion circuit 314 converts the voltage level of the temperature detection signal into a value within a desired range, which is then amplified by am amplifier 313 and converted into a digital signal by the analog-to-digital converter 315 for applying to the microprocessor 32.

The microprocessor 32 is programmed to process the digital signals from the analog-to-digital converter 315 and displays the processed data on the display device 34. In this respect, the microprocessor 32 can be any devices having known hardware or operated by known software to process and display the digital signals of the detected pressure and temperature.

The memory 33 stores data sets of standardized pressure and temperature of the refrigerant. The memory 33 is coupled to the microprocessor 32 whereby the microprocessor 32 can retrieve the data sets and display them on the display device 34.

The display device 34 can be of any known type and configuration. As an illustrative example, the display device 34 comprises a liquid crystal display (LCD), comprising a driver circuit 341, a display panel 342, and a backlight driving circuit 343. The driver circuit 341 is connected to the microprocessor 32 to receive data to be displayed from the microprocessor 32 and, in response thereto, drives the display panel 342 to show the data. The backlight driving circuit 343 is also under the control of the microprocessor 32 to timely generate back light for the LCD display panel 342.

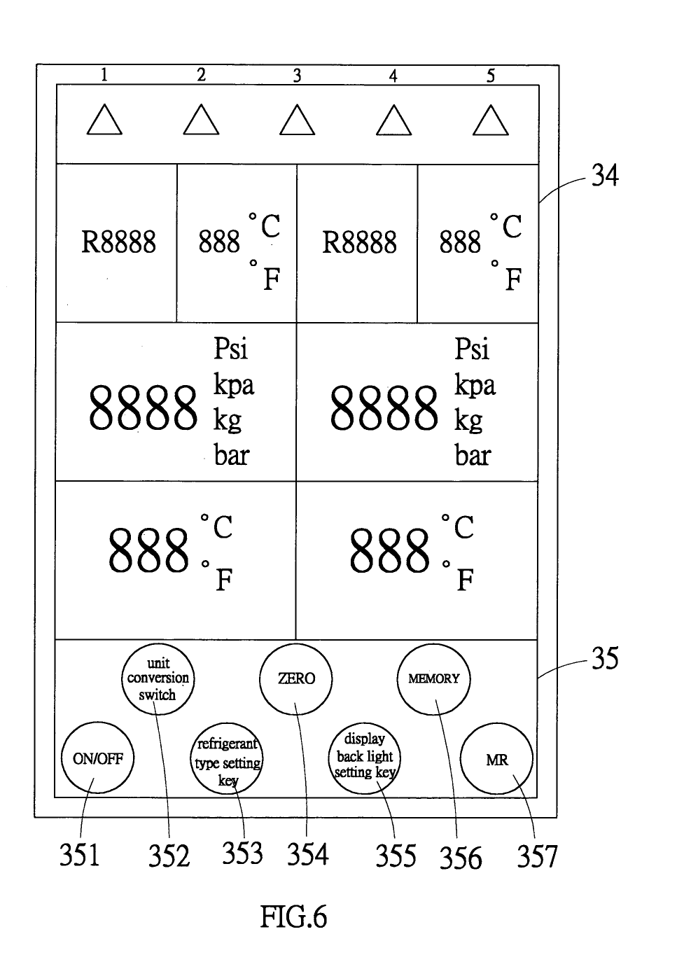

Also referring to FIG. 6, wherein an example of the display panel 342 of the display device 34 is shown, the display panel 342 has a display area that is divided into left and right (or first and second) display zones on which detected pressure and temperature of the refrigerant and standardized data sets of pressure and temperature are shown respectively. Such a display allows a user to directly compare the detected pressure and temperature with standardized data.

The keyboard 35 can be of any know types and configurations. An example illustrated in the embodiment in discussion comprises a thin-film touch-control keyboard, which in the embodiment is combined with the LCD display of the display device 34 and comprises a plurality of touch-control keys 351, 352, 353, 354, 355, 356, 357, which are, for example, a power switch, a unit conversion switch, a refrigerant type setting key, a reset key, a display back light setting key, a memorizing key, and a memory clear key. However, it is apparent that the keys can be arranged and set in different ways.

The power supply 36 serves to provide power to the sensor 20, the signal conversion circuit 31, the microprocessor 32, the memory 33, the display device 34, and the keyboard 35. The power supply 36 can be any power device that supplies the power, such as a battery set or a power adaptor connectable to a wall outlet.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A refrigerant measuring device, comprising:
a casing comprising a plurality of coupling connectors adapted to respectively couple to a source of refrigerant to be detected, the casing forming an internal channel connecting and in fluid communication with the coupling connectors to receive the refrigerant to be detected;
at least one sensor mounted to and in fluid communication with the channel to physically contact the refrigerant for detection of pressure and temperature of the refrigerant and generating pressure detection signal and temperature detection signal; and
a detection circuit comprising a signal conversion circuit that is coupled to the sensor to receive and convert the pressure detection signal and the temperature detection signal into signals applied to and processed by a processor-based electronic device, a memory storing sets of reference data of standardized pressure and temperature, an input device coupled to the processor-based electronic device to control the operation thereof for displaying the detected pressure and temperature of the refrigerant and selectively displaying the reference data of the standardized pressure and temperature on a display device, and a power supply powering the refrigerant measuring device.

2. The refrigerant measuring device as claimed in claim 1, wherein the signal conversion circuit comprises amplifiers, a voltage level conversion circuit, and an analog-to-digital converter.

3. The refrigerant measuring device as claimed in claim 2, wherein the voltage level conversion circuit comprises a transistor/thyristor based device.

4. The refrigerant measuring device as claimed in claim 1, wherein the display device comprises a liquid crystal display panel and a driver circuit for driving the panel, and a backlight driving circuit for selectively providing back light to the panel.

5. The refrigerant measuring device as claimed in claim 4, wherein the power supply comprises a battery set.

6. A refrigerant sensor comprising:
an enclosure having an end forming a connector that is adapted to connect a source of a refrigerant to be detected to receive the refrigerant, the enclosure forming an interior chamber in fluid communication with the connector by means of a pressure-reducing neck that reduces pressure of the refrigerant and guides the pressure-reduced refrigerant into the chamber;
a pressure detection chip extending into the chamber to detect the pressure of the refrigerant guided into the chamber; and
a thermocouple extending into the chamber to detect temperature of the refrigerant guided into the chamber.

7. The refrigerant sensor as claimed in claim 6, wherein the enclosure has an opposite end forming a bore in which a thread is formed.

8. The refrigerant sensor as claimed in claim 7 further comprising a lock plug that threadingly engages the threaded bore of the enclosure.

9. The refrigerant sensor as claimed in claim 6, wherein the enclosure defines two openings in fluid communication with the chamber, the pressure detection chip and the thermocouple extending through the openings respectively.

10. The refrigerant sensor as claimed in claim 6, wherein the pressure detection chip has a sensing end and a lead-connection end.
